(19) United States
(12) Patent Application Publication
(10) Pub. No.: US 2025/0291960 A1
(43) Pub. Date: Sep. 18, 2025

(54) IMAGE FORMING SYSTEM AND NON-TRANSITORY COMPUTER READABLE MEDIUM

(71) Applicant: FUJIFILM Business Innovation Corp., Tokyo (JP)

(72) Inventor: Manabu WADA, Kanagawa (JP)

(73) Assignee: FUJIFILM Business Innovation Corp., Tokyo (JP)

(21) Appl. No.: 18/780,716

(22) Filed: Jul. 23, 2024

(30) Foreign Application Priority Data
Mar. 18, 2024 (JP) 2024-042778

(51) Int. Cl. G06F 21/85; G06F 21/57

(52) U.S. Cl. CPC G06F 21/85; G06F 21/57

(57) ABSTRACT

An image forming system includes a first processor configured to: if a connection state upon startup of a USB device that includes a second processor for detecting tampering and communicates with outside has changed from a connected state to a non-connected state, store non-connection of the USB device in a predetermined storage unit and restart; and if the non-connection of the USB device is stored in the storage unit after the restart, perform a process of providing a notification of abnormality in the USB device.

### CROSS-REFERENCE TO RELATED APPLICATIONS

This application is based on and claims priority under 35 USC 119 from Japanese Patent Application No. 2024-042778 filed Mar. 18, 2024.

### BACKGROUND

### (i) Technical Field

The present disclosure relates to an image forming system and a non-transitory computer readable medium.

### (ii) Related Art

Japanese Unexamined Patent Application Publication No. 2023-112479 proposes an information processing apparatus which includes a main central processing unit (CPU) for executing various programs, a sub-CPU for performing verification for tampering of a startup program for the main CPU and a tamper-recovering process, a flash memory for storing startup code, a hardware sequencer for selectively switching between the main CPU and the sub-CPU so that one of them can access the flash memory, and a light-emitting diode (LED) having lighting and two types of blinking as notification patterns. The hardware sequencer varies the notification pattern of the LED in accordance with states of a tamper detection determination signal and an UNDER_RECOVERY signal from the sub-CPU.

Japanese Unexamined Patent Application Publication No. 2020-16927 proposes an information processing apparatus which includes a control means that controls a Universal Serial Bus (USB) device, and a USB cable that connects the control means and the USB device and that is used for exchange of data between the control means and the USB device. The information processing apparatus includes a detection means that detects that the USB device is attached to the control means, based on an output of a cable different from the USB cable.

### SUMMARY

In an image forming system to which a USB device that includes a tamper-detecting processor and that communicates with the outside can be connected, if the USB device detects tampering before USB initialization upon startup, the image forming system cannot detect connection of the USB device, and, therefore, starts up normally with no USB device. As a result, it is not possible to notify a user of tampering of the USB device.

Aspects of non-limiting embodiments of the present disclosure relate to providing an image forming system and a non-transitory computer readable medium storing an image forming program with which it is possible to notify a user of tampering of a USB device that includes a tamper-detecting processor and performs communication with the outside, even when the USB device detects tampering before USB initialization upon startup.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a first processor configured to: if a connection state upon startup of a USB device that includes a second processor for detecting tampering and communicates with outside has changed from a connected state to a non-connected state, store non-connection of the USB device in a predetermined storage unit and restart; and if the non-connection of the USB device is stored in the storage unit after the restart, perform a process of providing a notification of abnormality in the USB device.

### BRIEF DESCRIPTION OF THE DRAWINGS

Exemplary embodiments of the present disclosure will be described in detail based on the following figures, wherein:

FIG. 1 is a perspective view of the exterior of an image forming apparatus according to an exemplary embodiment;

FIG. 2 is a block diagram of a configuration of the major portions of an electrical system of the image forming apparatus according to the present exemplary embodiment;

FIG. 3 is a functional block diagram of an example of the functional configuration of a control unit of the image forming apparatus according to the present exemplary embodiment;

FIG. 4 illustrates a schematic configuration of hardware and software related to a facsimile card;

FIG. 5 is a sequence diagram of the flow of processing performed in the image forming apparatus according to the present exemplary embodiment;

FIG. 6 is a sequence diagram of an example of the flow of processing performed in the image forming apparatus according to the present exemplary embodiment after restart;

FIG. 7 illustrates an example of fail information;

FIG. 8 illustrates examples of screens for notification of non-connection of a facsimile;

FIG. 9 is a flowchart of an example of the flow of processing performed in the control unit of the image forming apparatus according to the present exemplary embodiment; and

FIG. 10 is a flowchart of an example of the flow of processing performed upon startup of the facsimile card.

### DETAILED DESCRIPTION

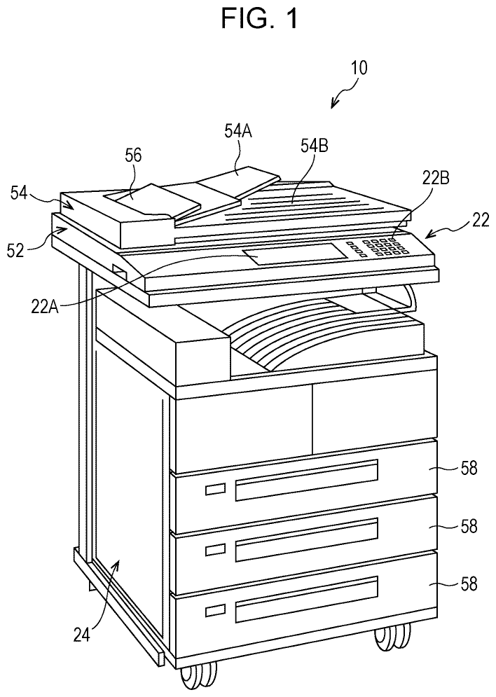

In the following, an exemplary embodiment of the present disclosure will be described in detail with reference to the drawings. In the present exemplary embodiment, an image forming apparatus will be described as an example of an image forming system. FIG. 1 is a perspective view of the exterior of an image forming apparatus 10 according to the present exemplary embodiment.

The image forming apparatus 10 according to the present exemplary embodiment has a print function for receiving various types of data via a communication line, such as a network, and performing an image forming process based on the received data. Furthermore, the image forming apparatus 10 according to the present exemplary embodiment has a plurality of functions such as a reading function for reading a document to obtain image information representing the document, a copying function for copying an image recorded on a document onto a sheet, a facsimile function for transmitting and receiving various types of data via a telephone line (not illustrated), a transfer function for transferring document information, such as the read image information obtained by the reading function, and a storage function for storing document information, such as the read image information.

The image forming apparatus 10 according to the present exemplary embodiment also includes a document reading unit 52 at the top of the apparatus, and an image forming unit 24 is disposed below the document reading unit 52. The document reading unit 52 includes a document transport unit (not illustrated) in a document covering 54. The document transport unit sequentially draws in documents 56 placed on a document feed part 54A of the document covering 54, and transport the documents 56 onto a platen glass (not illustrated) where images recorded on the documents 56 are read. The document transport unit ejects the documents 56 whose image has been read onto a document ejection part 54B of the document covering 54.

The document reading unit 52 is also provided with a user interface 22 for receiving various instruction operations by a user. The user interface 22 includes, for example, a display 22A on which display buttons for implementing the acceptance of instruction operations by a software program and various information are displayed, and hardware keys 22B such as a numeric keypad. The display 22A is of a touch panel type that is a combination of a display device, such as a liquid crystal panel, and a position input device, such as a touch pad. The user interface 22 is used to set, with the display buttons of the display 22A or the hardware keys 22B, the number of copies and the magnification when the copying function is used, and is used as the dial keys of a telephone when the facsimile function is used. The hardware keys 22B may be omitted.

On the other hand, the image forming unit 24 includes sheet storage units 58 in each of which sheets serving as recording media for image formation are stored. In the image forming unit 24, the sheets stored in the sheet storage unit 58 are taken out one by one, and an image based on image data is formed on the sheet by, for example, an electrophotographic process. Sheets on which images have been formed by the image forming unit 24 are sequentially ejected onto an ejected sheet unit (not illustrated).

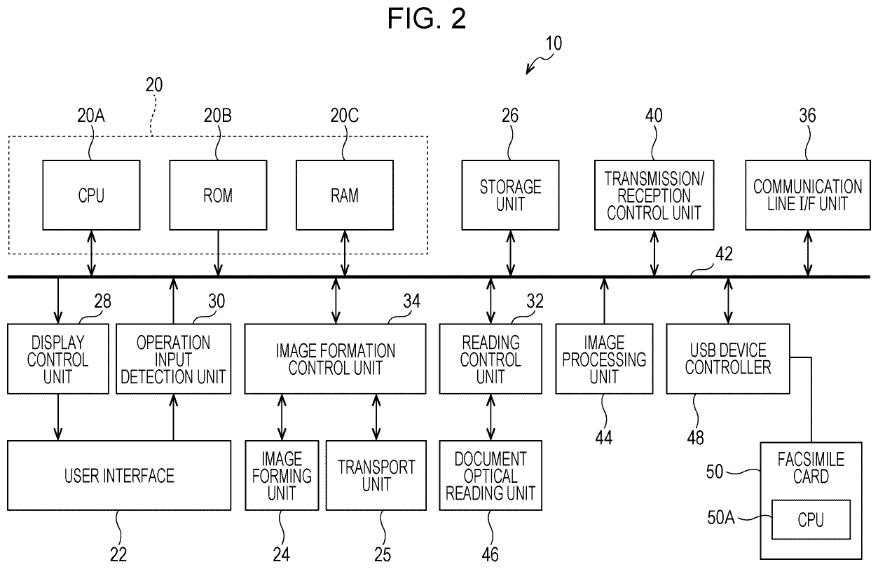

FIG. 2 is a block diagram of a configuration of the major portions of the electrical system of the image forming apparatus 10 according to the present exemplary embodiment.

As illustrated in FIG. 2, the image forming apparatus 10 according to the present exemplary embodiment includes a control unit 20 which includes a CPU 20A as an example of a first processor, a read-only memory (ROM) 20B, and a random access memory (RAM) 20C. The CPU 20A governs the overall operation of the image forming apparatus 10. The RAM 20C is used as a work area or the like during execution of various programs by the CPU 20A. Various control programs, various parameters, and the like are stored in advance in the ROM 20B. In the image forming apparatus 10, the parts of the control unit 20 are electrically connected by a system bus 42.

Further, the image forming apparatus 10 according to the present exemplary embodiment includes a storage unit 26 that stores various types of data, application programs, and the like. The image forming apparatus 10 further includes a display control unit 28 that is connected to the user interface 22 to control the display of various operating screens and the like on the display 22A of the user interface 22. The image forming apparatus 10 also includes an operation input detection unit 30 that is connected to the user interface 22 to detect an operation instruction input via the user interface 22. The storage unit 26, the display control unit 28, and the operation input detection unit 30 are electrically connected to the system bus 42 in the image forming apparatus 10. As the storage unit 26, a hard disk drive (HDD) or a nonvolatile storage unit, such as a flash memory, may be employed, for example.

In addition, the image forming apparatus 10 according to the present exemplary embodiment includes a reading control unit 32 that controls an optical image reading operation by a document optical reading unit 46 and a document feeding operation by the document transport unit, and an image formation control unit 34 that controls an image forming process by the image forming unit 24 and transport of a sheet to the image forming unit 24 by a transport unit 25. In addition, the image forming apparatus 10 includes a communication line interface (I/F) unit 36 that is connected to a communication line (not illustrated) to transmit and receive communication data to and from an external apparatus, such as a server connected to the communication line, and an image processing unit 44 that performs various kinds of image processing. The image forming apparatus 10 further includes a USB device controller 48 to which a facsimile card 50 is connectable which is connected to a telephone line (not illustrated) and transmits and receives facsimile data to and from a facsimile device connected to the telephone line. The image forming apparatus 10 further includes a transmission/reception control unit 40 that controls transmission and reception of facsimile data via the facsimile card 50. In the image forming apparatus 10, the transmission/reception control unit 40, the reading control unit 32, the image formation control unit 34, a communication line interface unit 36, the image processing unit 44, and the USB device controller 48 are electrically connected to the system bus 42. In addition to the facsimile card 50, USB devices such as external connection devices are connectable to the USB device controller 48. Examples of the external connection devices include a medium reader and a multi factor information reading device for reading multi factor information such as biometric information about a fingerprint, a face, a vein, an iris, a voiceprint, and a signature. While in the present exemplary embodiment, the facsimile card 50 is employed as an example of a USB device, the USB device is not limited thereto. Any other USB device may be employed as long as it includes a processor for detecting tampering and performs communication with the outside.

With the above-described configuration, in the image forming apparatus 10 according to the present exemplary embodiment, the CPU 20A performs access to each of the RAM 20C, the ROM 20B, and the storage unit 26. Further, in the image forming apparatus 10, the CPU 20A performs control of the display of an operating screen and information, such as various messages, on the display 22A of the user interface 22 via the display control unit 28. In addition, in the image forming apparatus 10, the CPU 20A controls the operation of the document optical reading unit 46 and the document transport unit via the reading control unit 32. Furthermore, in the image forming apparatus 10, the CPU 20A performs control of the operation of the image forming unit 24 and the transport unit 25 via the image formation control unit 34, and control of communication data transmission and reception via the communication line interface unit 36. Further, in the image forming apparatus 10, the CPU 20A performs control of facsimile data transmission and reception via the facsimile card 50 by the transmission/reception control unit 40. Furthermore, in the image forming apparatus 10, the CPU 20A ascertains the operation contents in the user interface 22 based on the operation information detected by the operation input detection unit 30, and performs various kinds of control based on the operation contents.

Further, the facsimile card 50 includes a processor, such as a CPU 50A, as an example of a second processor that detects tampering, and communicates with the outside.

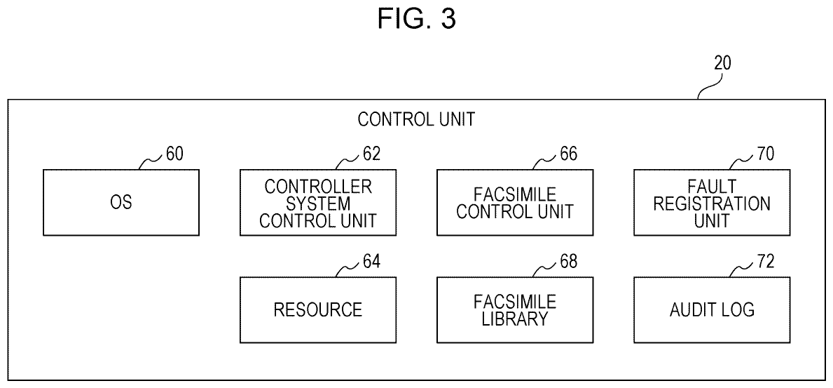

Next, a functional configuration implemented in the image forming apparatus 10 according to the present exemplary embodiment by the CPU 20A of the control unit 20 loading a program stored in the ROM 20B into the RAM 20C and executing the program will be described. FIG. 3 is a functional block diagram illustrating an example of the functional configuration of the control unit 20 of the image forming apparatus 10 according to the present exemplary embodiment.

The control unit 20 has functions of an operating system (OS) 60, a controller system control unit 62, a resource 64, a facsimile control unit 66, a facsimile library 68, a fault registration unit 70, and an audit log 72.

The OS 60 is software necessary for operating the image forming apparatus 10 and using applications for executing various functions, such as printing, reading, copying, facsimile, transfer, and storage functions.

The controller system control unit 62 controls the operation of various functions of the image forming apparatus 10 and performs settings and the like. In the present exemplary embodiment, the controller system control unit 62 controls a configuration change, such as whether or not the facsimile card 50 is connected to the USB device controller 48.

The resource 64 stores various settings set by the controller system control unit 62. For example, the presence or absence of connection of the facsimile card 50 is stored. Note that the storage unit 26 may be employed for the resource 64.

The facsimile control unit 66 controls the transmission/reception control unit 40 to control transmission and reception of facsimile data via the facsimile card 50.

The facsimile library 68 performs processing for storing settings of various functions in the resource 64. For example, when there is a change in the facsimile configuration, the facsimile library 68 stores the change in the facsimile configuration in the resource 64.

The fault registration unit 70 registers a configuration change or the like of the image forming apparatus 10 as fail information. For example, the fault registration unit 70 registers fail information indicating that the facsimile configuration has been changed due to tampering of the facsimile card 50.

When the facsimile configuration is changed, the audit log 72 stores the tampering of the facsimile card 50 as a history.

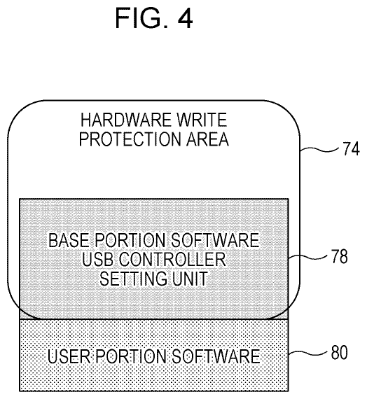

FIG. 4 is a diagram illustrating a schematic configuration of hardware and software related to the facsimile card 50.

As illustrated in FIG. 4, the facsimile card 50 has a hardware write protection area 74, a base-portion software USB controller setting unit 78, and a user-portion software 80.

In the image forming apparatus 10 according to the present exemplary embodiment, if the facsimile card 50 detects tampering of the hardware write protection area 74 which is write-protected before USB initialization upon startup of the facsimile card 50, the control unit 20 cannot detect the connection of the facsimile. As a result, the image forming apparatus starts up normally with no facsimile, and cannot notify the user of the tampering of the facsimile firmware. Also, due to write-protection, resilience cannot be performed, either.

Therefore, according to the present exemplary embodiment, the image forming apparatus 10, if the connection state upon startup of the facsimile card 50, as an example of a USB device, has changed from a connected state to a non-connected state, stores the non-connection of the facsimile card 50 in the resource 64 and starts, and if the non-connection of the facsimile card 50 is stored in the resource 64 after the restart, performs a process of providing a notification of abnormality in the facsimile card 50.

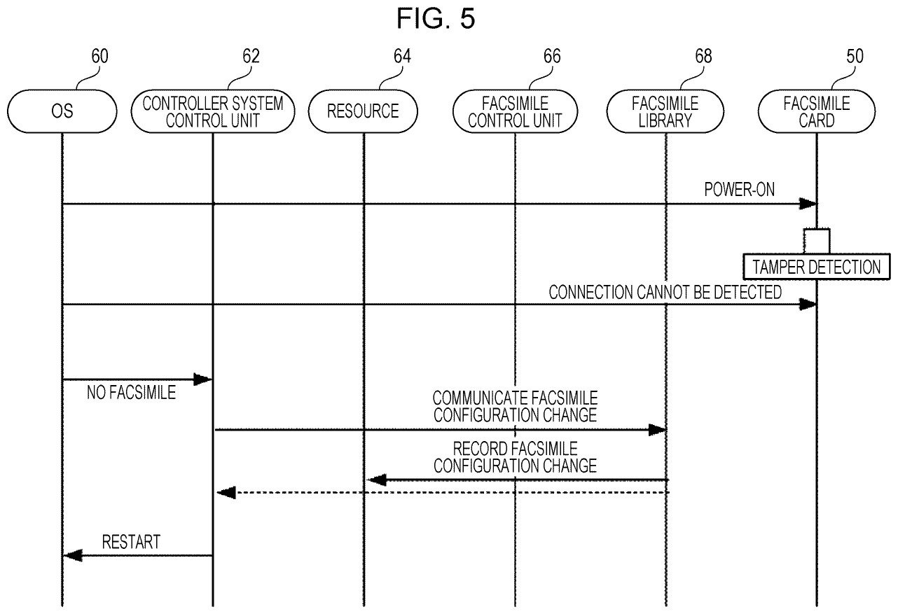

Here, the above-described processing performed in the image forming apparatus 10 will be described in detail. FIG. 5 is a sequence diagram of the flow of the processing performed in the image forming apparatus 10 according to the present exemplary embodiment.

As illustrated in FIG. 5, upon the system startup, the OS 60 powers on the facsimile card 50.

The facsimile card 50 performs tamper detection. Here, if tampering is detected, the OS 60 cannot detect connection of the facsimile card 50, and therefore notifies the controller system control unit 62 of no facsimile.

The controller system control unit 62 communicates the facsimile configuration change to the facsimile library 68. The facsimile library 68 records the non-connection of the facsimile in the resource 64 as a facsimile configuration change.

After the resource 64 is notified of the facsimile configuration change, the controller system control unit 62 restarts the OS 60 in order to change the software configuration to a no-facsimile software configuration.

Even if the fail information is brought up before the restart, the user cannot see the fail information later because of the restart. The restart is performed because the OS 60, in order to shorten the startup time, begins startup by creating a software configuration with a stored hardware configuration. Therefore, when a change in the hardware configuration is detected during the startup, the stored hardware configuration is updated and the OS 60 is restarted to start with a software configuration for the latest hardware configuration.

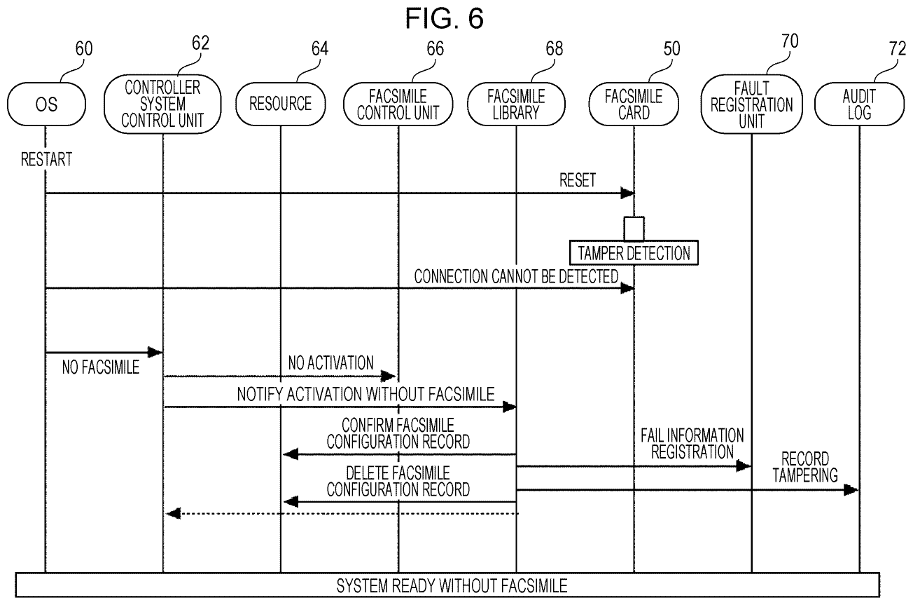

FIG. 6 is a sequence diagram of an example of the flow of processing performed after the restart in the image forming apparatus 10 according to the present exemplary embodiment. As illustrated in FIG. 6, upon restart, the OS 60 resets the facsimile card 50.

The facsimile card 50 performs tamper detection. Here, if tampering is detected, the OS 60 cannot detect connection of the facsimile card 50, and therefore notifies the controller system control unit 62 of no facsimile.

The controller system control unit 62 notifies the facsimile control unit 66 of not starting the facsimile and informs the facsimile library 68 about startup with no facsimile.

The facsimile library 68 confirms the facsimile configuration record of the resource 64. Here, the facsimile library 68 registers the fail information in the fault registration unit 70, and records the tampering in the audit log 72. Then, the facsimile library 68 deletes the facsimile configuration record of the resource 64, and notifies the controller system control unit 62 of the deletion. Thus, the system ready state is attained with no facsimile.

That is, after the restart, it is confirmed whether the facsimile has become non-connected based on the recorded information, and, if the result of the confirmation indicates that the facsimile has become non-connected, the fail information is brought up to notify the user that the facsimile has become non-connected. For example, the non-connection of the facsimile may be displayed on the display 22A to notify the user. Since there is a possibility that tampering has not actually been detected, it may be described by a manual that there is a possibility of tampering as another factor.

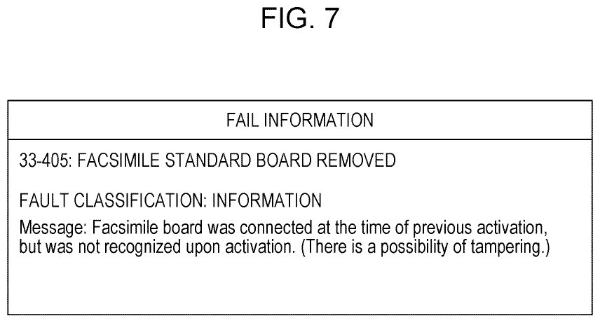

As the fail information registered in the fault registration unit 70, fail information illustrated in FIG. 7 is registered, for example. FIG. 7 is an example of the fail information. In the example of FIG. 7, a fail number is “33-405”, which is fail information indicating that the facsimile standard board has been removed. FIG. 7 illustrates an example in which a fault classification is “information” and a message “Facsimile board was connected at the time of previous startup but has not been recognized upon startup” are registered as the fail information.

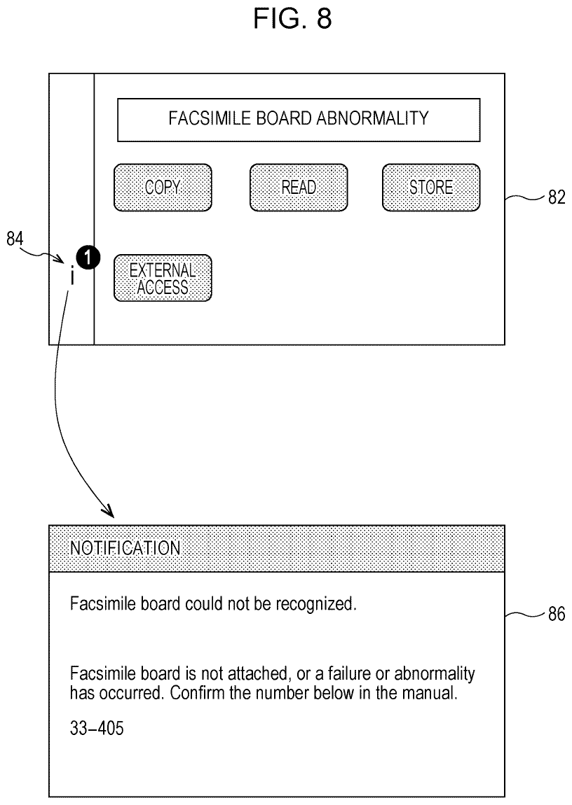

As a method for providing a notification of the non-connection of the facsimile, screens illustrated in FIG. 8 may be displayed on the display 22A. FIG. 8 illustrates examples of screens for notification of non-connection of the facsimile. FIG. 8 illustrates an example in which a message “facsimile board abnormality” is displayed on a menu screen 82. Further, an information icon 84 as an example of a link for displaying the contents of the abnormality may be displayed on the menu screen 82 of FIG. 8. When the information icon 84 is operated, a notification screen 86 may be displayed as illustrated on the lower side of FIG. 8. The example of the notification screen 86 of FIG. 8 presents an example in which a message “Facsimile board could not be recognized. Facsimile board is not attached, or a failure or abnormality has occurred. Confirm the number below in the manual: 33-405” is displayed as a notification message.

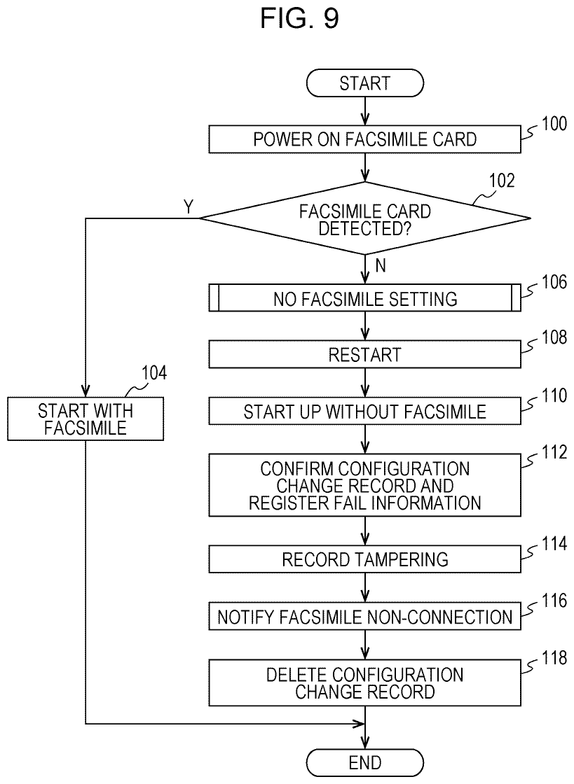

Next, specific processing performed in the image forming apparatus 10 according to the present exemplary embodiment configured as described above will be described. FIG. 9 is a flowchart of an example of the flow of processing performed in the control unit 20 of the image forming apparatus 10 according to the present exemplary embodiment. The processing of FIG. 9 is started, for example, when a power switch (not illustrated) of the image forming apparatus 10 is turned on.

In step 100, the CPU 20A powers on the facsimile card 50, and the process proceeds to step 102. That is, the OS 60 powers on the facsimile card 50.

In step 102, the CPU 20A determines whether or not the facsimile card 50 has been detected. If the determination is affirmative, the process proceeds to step 104; if negative, the process proceeds to step 106.

In step 104, the CPU 20A starts up with facsimile, ends the series of processing, and enters a system ready state with facsimile.

On the other hand, in step 106, the CPU 20A executes no-facsimile setting processing, and the process proceeds to step 108. In the no-facsimile setting processing, the sequence up to the restart illustrated in FIG. 5 is performed. That is, the OS 60 notifies the controller system control unit 62 of no facsimile, the controller system control unit 62 informs the facsimile library 68 about the facsimile configuration change, and the facsimile library 68 records the non-connection of the facsimile in the resource 64 as a facsimile configuration change.

In step 108, the CPU 20A restarts, and the process proceeds to step 110. That is, after the facsimile configuration change notification to the resource 64, the controller system control unit 62 restarts the OS 60 in order to change the software configuration to a no-facsimile software configuration.

In step 110, the CPU 20A starts up with no facsimile, and the process proceeds to step 112. That is, the controller system control unit 62 notifies the facsimile control unit 66 that the facsimile is not started, and informs the facsimile library 68 about startup with no facsimile.

In step 112, the CPU 20A confirms the configuration change record, and registers the fail information, and the process proceeds to step 114. That is, the facsimile library 68 confirms the facsimile configuration record of the resource 64, and registers the fail information in the fault registration unit 70.

In step 114, the CPU 20A records the tampering, and the process proceeds to step 116. That is, the facsimile library 68 records the tampering in the audit log 72.

In step 116, the CPU 20A provides a notification of facsimile non-connection, and the process proceeds to step 118. For example, the message indicating facsimile non-connection as illustrated in FIG. 8 is displayed on the menu screen 82 displayed on the display 22A. In this way, the user can be notified of the possibility of tampering of the facsimile card 50.

In step 118, the CPU 20A deletes the configuration change record, ends the series of processing, and enters a system ready state with no facsimile. That is, the facsimile library 68 deletes the facsimile configuration record of the resource 64, and notifies the controller system control unit 62 of the deletion.

By performing such processing, even if the facsimile card 50 detects tampering before the USB initialization upon startup, it is possible to notify the user of the tampering of the facsimile card 50 because the fail information is registered in the fault registration unit 70 and the tampering is recorded in the audit log 72. Further, since the non-connection of the facsimile is displayed on the menu screen 82, it is also possible to notify the user of the tampering of the facsimile card 50. Further, since the notification screen 86 is displayed, the contents of the fail information can be confirmed.

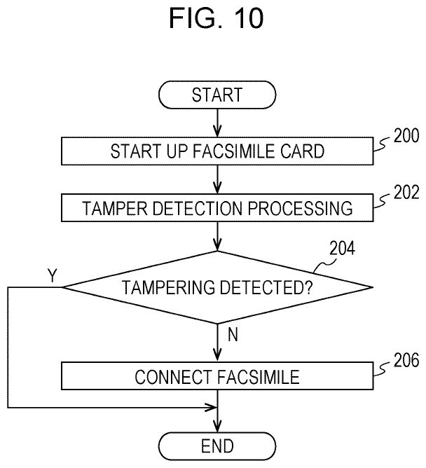

Next, specific processing performed upon startup of the facsimile card 50 will be described. FIG. 10 is a flowchart of an example of the flow of processing performed upon startup of the facsimile card 50. The processing of FIG. 10 starts, for example, when startup or restart is performed from the OS 60.

In step 200, the CPU 50A starts up the facsimile card 50, and the process proceeds to step 202.

In step 202, the CPU 50A performs tamper detection processing, and the process transitions to step 204.

In step 204, the CPU 50A determines whether tampering has been detected. If the determination is affirmative, the series of processing upon startup ends; if negative, the process proceeds to step 206.

In step 206, the CPU 50A establishes a facsimile connection and ends the processing upon startup.

In the above-described exemplary embodiment, a notification of the abnormality in the USB device is provided by performing the registration of the fail information in the fault registration unit 70, the recording of the tampering in the audit log 72, and the display of the abnormality on the menu screen 82, for example. However, the method of notifying the user is not limited to the above. For example, a mobile terminal, a client terminal, or the like of the user may be registered in advance, and the registered terminal may be notified of the abnormality.

In the exemplary embodiment above, the term “processor” refers to a processor in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

The operation of the processor in the above-described exemplary embodiment may be performed not only by one processor but also by a plurality of processors at physically distant positions co-operating with each other. The order of operations of the processor is not limited to one described in the exemplary embodiments above, and may be changed.

The “system” according to the present exemplary embodiment may be constituted by a plurality of apparatuses, or may be constituted by a single apparatus having some of the functions of a plurality of apparatuses.

The processing performed in the image forming apparatus 10 according to the above-described exemplary embodiment may be processing performed by software, processing performed by hardware, or processing performed by a combination of both. The processing performed in the image forming apparatus 10 may be stored as a program in a storage medium and distributed.

The present disclosure is not limited to the foregoing, and it is needless to say that the present disclosure may be variously modified and implemented without departing from the spirit and scope thereof.

### APPENDIX

(((1)))

An image forming system comprising:
a first processor configured to:
   if a connection state upon startup of a USB device that includes a second processor for detecting tampering and communicates with outside has changed from a connected state to a non-connected state, store non-connection of the USB device in a predetermined storage unit and restart; and
   if the non-connection of the USB device is stored in the storage unit after the restart, perform a process of providing a notification of abnormality in the USB device.
      (((2)))

The image forming system according to (((1))), wherein the USB device is a USB-connection facsimile card.

(((3)))

The image forming system according to (((1))) or (((2))), wherein the first processor is configured to perform, as the process of providing a notification of abnormality, a process of registering the non-connection of the USB device as detection of tampering, in a history.

(((4)))

The image forming system according to any one of (((1))) to (((3))), wherein the first processor is configured to display information indicating the abnormality on a menu screen as the process of providing a notification of abnormality.

(((5)))

The image forming system according to (((4))), wherein the first processor is configured to further display, on the menu screen, a link for displaying contents of the abnormality.

(((6)))

The image forming system according to (((5))), wherein the first processor is configured to, if the link is operated, display the non-connection of the USB device as the contents of the abnormality.

(((7)))

The image forming system according to (((6))), wherein the first processor is configured to further display, in addition to the non-connection, a message for prompting confirmation of a manual.

(((8)))

A program causing a computer to execute a process for image formation, the process comprising:
if a connection state upon startup of a USB device that includes a processor for detecting tampering and communicates with outside has changed from a connected state to a non-connected state, storing non-connection of the USB device in a predetermined storage unit and restarting; and
if the non-connection of the USB device is stored in the storage unit after the restart, providing a notification of abnormality in the USB device.

What is claimed is:

1. An image forming system comprising:
a first processor configured to:
if a connection state upon startup of a USB device that includes a second processor for detecting tampering and communicates with outside has changed from a connected state to a non-connected state, store non-connection of the USB device in a predetermined storage unit and restart; and
if the non-connection of the USB device is stored in the storage unit after the restart, perform a process of providing a notification of abnormality in the USB device.

2. The image forming system according to claim 1, wherein the USB device is a USB-connection facsimile card.

3. The image forming system according to claim 1, wherein the first processor is configured to perform, as the process of providing a notification of abnormality, a process of registering the non-connection of the USB device as detection of tampering, in a history.

4. The image forming system according to claim 1, wherein the first processor is configured to display information indicating the abnormality on a menu screen as the process of providing a notification of abnormality.

5. The image forming system according to claim 4, wherein the first processor is configured to further display, on the menu screen, a link for displaying contents of the abnormality.

6. The image forming system according to claim 5, wherein the first processor is configured to, if the link is operated, display the non-connection of the USB device as the contents of the abnormality.

7. The image forming system according to claim 6, wherein the first processor is configured to further display, in addition to the non-connection, a message for prompting confirmation of a manual.

8. A non-transitory computer readable medium storing a program causing a computer to execute a process for image formation, the process comprising:
if a connection state upon startup of a USB device that includes a processor for detecting tampering and communicates with outside has changed from a connected state to a non-connected state, storing non-connection of the USB device in a predetermined storage unit and restarting; and
if the non-connection of the USB device is stored in the storage unit after the restart, providing a notification of abnormality in the USB device.
